(19) United States
(12) Patent Application Publication
(10) Pub. No.: US 2020/0234532 A1
(43) Pub. Date: Jul. 23, 2020

(54) GAME DEVICE AND GAME METHOD

(71) Applicant: SEGA SAMMY CREATION INC., Yokohama-shi, Kanagawa (JP)

(72) Inventor: Satoshi Arashima, Yokohama-shi (JP)

(21) Appl. No.: 16/492,403

(22) PCT Filed: Mar. 25, 2019
(86) PCT No.: PCT/JP2019/012399

§ 371 Date: Sep. 9, 2019

(30) Foreign Application Priority Data
Mar. 30, 2018 (JP) PCT/JP2018/013945

(51) Int. Cl. G07F 17/32; G07F 17/34

(52) U.S. Cl. CPC G07F 17/3213; G07F 17/329; G07F 17/34; G07F 17/3262; G07F 17/3267

(57) ABSTRACT

A game device comprises: a selection unit for selecting a self-character and an opponent character; a display control unit for displaying at least one of a first symbol allocated to the self-character and a second symbol allocated to the opponent character at rest; a point control unit for decreasing a first point allocated to the self-character when the number of the second symbols displayed at rest is larger than the number of the first symbols, and decreasing a second point allocated to the opponent character when the number of the second symbols displayed at rest is smaller than the number of the first symbols; a determination unit for determining that a character whose point has reached the threshold or less was defeated; and a dividend unit for paying a predetermined dividend amount when it is determined that the self-character beat the opponent character.

### CROSS-REFERENCE TO RELATED APPLICATIONS

This application is the U.S. national phase of the International Patent Application No. PCT/JP2019/012399 filed Mar. 25, 2019, which claims the priority benefit of the International Patent Application No. PCT/JP2018/013945, filed Mar. 30, 2018, the contents of each being incorporated herein by reference.

### TECHNICAL FIELD

The present disclosure relates to a game device and a game method.

### BACKGROUND

In recent years, a large number of game devices capable of playing slot games by using a computer have been developed. Some of the slot games provide a bonus game comprising a battle of characters to players when a predetermined condition is satisfied in a normal game as a general slot game.

For example, Japanese Patent No. 6198923 B1 discloses a game machine comprising character selection means. The character selection means comprises at least lottery data used for a battle between a self-character and an enemy character and lottery data used for a battle between one of a plurality of enemy characters and another enemy character. The character selection means is formed such that when each character receives a predetermined attach from another character, the character can become a loser in the battle to be knocked out of the battle and a benefit can be given to a self-character that has not been knocked out of the battle.

### SUMMARY

The game machine, however, does not provide a knockout competition where the self-character beats enemy characters one by one, which is underwhelming.

It is therefore an object to provide a technology related to a game capable of providing an impressive knockout competition such that a large number of players can be attracted to produce a large amount of income.

A game device according to an embodiment comprises: a selection unit for selecting one self-character allocated to a player, and selecting one opponent character, which is an opponent for the self-character; a display control unit for displaying, on the basis of a lottery, at least one of a first symbol allocated to the self-character and a second symbol allocated to the opponent character at rest in separate regions of a plurality of display regions; a point control unit for giving a point to a first point allocated to the self-character or a second point allocated to the opponent character in accordance with numbers of the first symbols and the second symbols displayed at rest; a determination unit for determining, when any one of the first point and the second point has reached a predetermined threshold, that a character whose point has reached the threshold won and a character which is an opponent for the winning character was defeated; and a dividend unit for paying a predetermined dividend when it is determined that the self-character beat the opponent character.

A game device according to an embodiment comprises: a selection unit for selecting one self-character allocated to a player, and selecting one opponent character, which is an opponent for the self-character; a display control unit for displaying, on the basis of a lottery, at least one of a first symbol allocated to the self-character and a second symbol allocated to the opponent character at rest in separate regions of a plurality of display regions; a point control unit for decreasing a first point allocated to the self-character when a number of the second symbols displayed at rest is larger than a number of the first symbols displayed at rest, and decreasing a second point allocated to the opponent character when the number of the second symbols displayed at rest is smaller than the number of the first symbols displayed at rest; a determination unit for determining, when any one of the first point and the second point has reached a predetermined threshold or less, that a character whose point has reached the threshold or less was defeated and a character which is an opponent for the losing character won; and a dividend unit for paying a predetermined dividend when it is determined that the self-character beat the opponent character.

A game method according to an embodiment comprises the steps of: selecting one self-character allocated to a player, and selecting one opponent character, which is an opponent for the self-character; displaying, on the basis of a lottery, at least one of a first symbol allocated to the self-character and a second symbol allocated to the opponent character at rest in separate regions of a plurality of display regions; decreasing a first point allocated to the self-character when a number of the second symbols displayed at rest is larger than a number of the first symbols displayed at rest, and decreasing a second point allocated to the opponent character when the number of the second symbols displayed at rest is smaller than the number of the first symbols displayed at rest; determining, when any one of the first point and the second point has reached a predetermined threshold or less, that a character whose point has reached the threshold or less was defeated and a character which is an opponent for the losing character won; and paying a predetermined dividend when it is determined that the self-character beat the opponent character.

According to the present disclosure, it is an object to provide a technology related to a game capable of providing an impressive knockout competition such that a large number of players can be attracted to produce a large amount of income.

### BRIEF DESCRIPTION OF THE DRAWINGS

Various embodiments are illustrated in the drawings, in which:

FIG. 1 is a diagram illustrating the appearance of a game device according to an embodiment.

FIG. 2 is a block diagram illustrating a main hardware configuration of the game device according to the embodiment.

FIG. 3 is a block diagram illustrating a main functional configuration of the game device according to the embodiment.

FIG. 4 is a diagram illustrating an example of images displayed on a display unit when a condition to start a bonus game is satisfied in a normal game provided by the game device according to the embodiment.

FIG. 5 is a diagram illustrating an example of images displayed on the display unit in the bonus game provided by the game device according to the embodiment.

FIG. 6 is a diagram illustrating an example in which the number of second symbols displayed at rest is larger than the number of first symbols displayed at rest in the bonus game provided by the game device according to the embodiment.

FIG. 7 is a diagram illustrating an example in which the number of second symbols displayed at rest is smaller than the number of first symbols displayed at rest in the bonus game provided by the game device according to the embodiment.

FIG. 8 is a diagram illustrating an example in which a special symbol is displayed at rest in the bonus game provided by the game device according to the embodiment.

FIG. 9 is a diagram illustrating an example in which symbols having a predetermined positional relationship with the special symbol are rewritten by first symbols in the bonus game provided by the game device according to the embodiment.

FIG. 10 is a flowchart for describing an example of the flow of the bonus game provided by the game device according to the embodiment.

FIG. 11 is a flowchart for describing an example of the flow of the bonus game provided by the game device according to the embodiment.

FIG. 12 is a diagram illustrating an example of images displayed on the display unit in the bonus game provided by the game device according to the embodiment.

FIG. 13 is a diagram illustrating an example of images displayed on a display unit in a bonus game provided by a game device according to a modified example.

### DETAILED DESCRIPTION

An embodiment of the present disclosure is described below with reference to the drawings. The embodiment described below is merely an example, and is not intended to exclude various modifications and applications of technologies that are not specified. In the drawings, the same portions are denoted by the same reference symbols. The figures are schematic, and do not necessarily match the actual dimensions and ratios. Some parts having different relations of dimensions and ratios are included in the figures.

### Description of Configuration

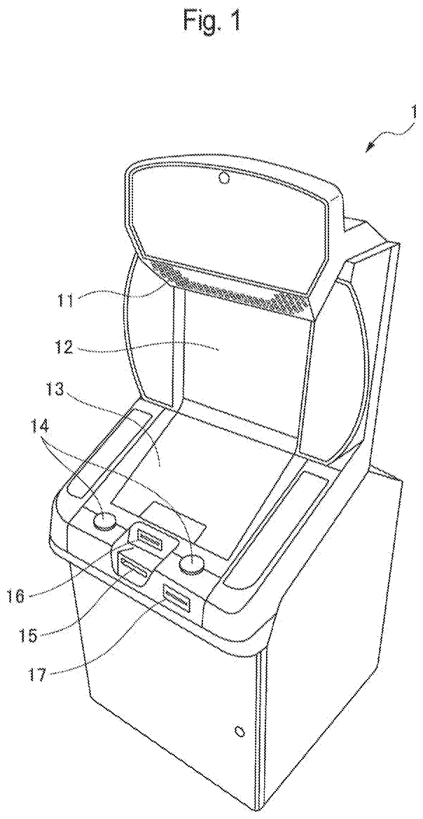

Referring to FIG. 1 to FIG. 3, a game device according to an embodiment is described. FIG. 1 is a diagram illustrating the appearance of the game device according to the embodiment.

A game device 1 is a slot machine installed at a game hall, such as a casino and an amusement facility.

For example, as illustrated in FIG. 1, the game device 1 comprises a speaker 11, a display unit 12, a display unit 13, an operation input unit 14, a card reading unit 15, a bill insertion unit 16, and a ticket withdrawal unit 17.

The speaker 11 outputs sound related to a game, for example, voice guidance and sound effects in a slot game. The display unit 12 and the display unit 13 are means for presenting images related to a game to a player, and are, for example, a display illustrated in FIG. 1. The display unit 12 and the display unit 13 display images for expressing or producing a slot game. The operation input unit 14 is hardware for inputting an instruction from the player to the game device 1, and comprises, for example, a start button.

The card reading unit 15 reads information from a card owned by a player. The card is a medium in which playing information on the player is stored. For example, the card stores points acquired by the past results of slot games. The player receives various services depending on the playing information stored in the card. However, the contents stored in the card have no influence on the results of slot games. The bill insertion unit 16 is a device for reading an inserted bill or ticket. The ticket withdrawal unit 17 withdraws a ticket to the player.

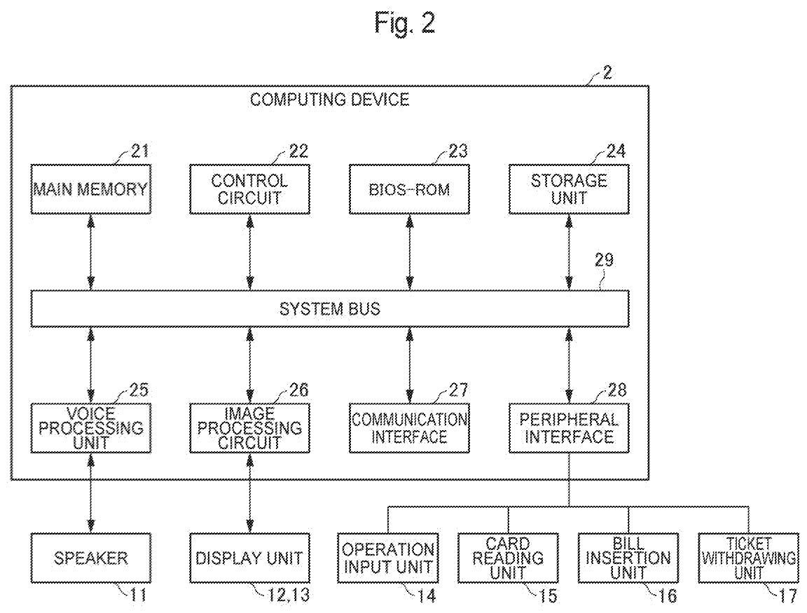

FIG. 2 is a block diagram illustrating a main hardware configuration of the game device according to the embodiment. For example, as illustrated in FIG. 2, the game device 1 comprises a computing device 2 in addition to the speaker 11, the display unit 12, the display unit 13, the operation input unit 14, the card reading unit 15, the bill insertion unit 16, and the ticket withdrawal unit 17.

The computing device 2 comprehensively controls the game device 1. The computing device 2 comprises various kinds of processors and memories, and, for example, comprises a computer circuit element having a chip set. For example, the computing device 2 comprises a main memory 21, a control circuit (CPU (Central Processing Unit)) 22, BIOS (Basic Input/Output System)-ROM (Read Only Memory) 23, a storage unit 24, a voice processing unit 25, an image processing circuit 26, a communication interface 27, a peripheral interface 28, and a system bus 29.

In the main memory 21, a software program for executing a slot game is deployed, and information necessary for executing the software program is stored. The control circuit 22 executes the software program to cause the computing device 2 to implement various kinds of functions. In other words, the computing device 2 implements a slot game in cooperation with other hardware when the control circuit 22 executes a software program deployed on the main memory 21.

The BIOS-ROM 23 is a ROM storing a BIOS, which is lower layer software for directly operating the hardware. The BIOS initializes the game device 1 and the computing device 2, and invokes a bootloader. The BIOS is an upper layer application and provides an intervening layer necessary for a software program for executing a slot game to function the game device 1 or the computing device 2 as hardware resources.

The storage unit 24 stores software programs and various kinds of data necessary for executing a slot game. The voice processing unit 25 performs various kinds of sound processing under control of the control circuit 22. The image processing circuit 26 performs various kinds of graphics processing under control of the control circuit 22. The communication interface 27 is an interface for achieving communication with a server or another game device. The peripheral interface 28 is an interface for achieving communication to the operation input unit 14, the card reading unit 15, the bill insertion unit 16, or the ticket withdrawal unit 17 and the computing device 2.

As illustrated in FIG. 2, the system bus 29 is connected to the main memory 21, the control circuit 22, the BIOS-ROM 23, the storage unit 24, the voice processing unit 25, the image processing circuit 26, the communication interface 27, and the peripheral interface 28. For example, the system bus 29 transmits addresses of these units, data exchanged therebetween, and signals for controlling these units.

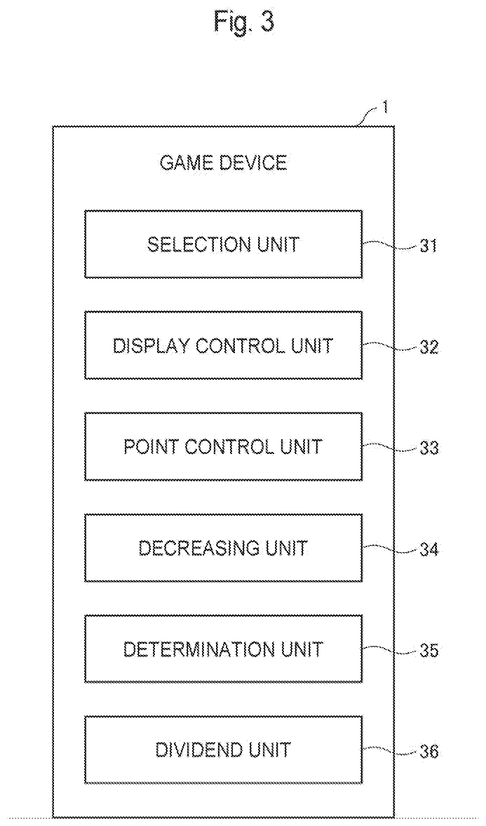

FIG. 3 is a block diagram illustrating a main functional configuration of the game device according to the embodiment. For example, as illustrated in FIG. 3, the game device 1 comprises a selection unit 31, a display control unit 32, a rewriting unit 33, a point control unit 34, a determination unit 35, and a dividend unit 36. These units are functionally implemented by the control circuit 22 executing a software program deployed on the main memory 21.

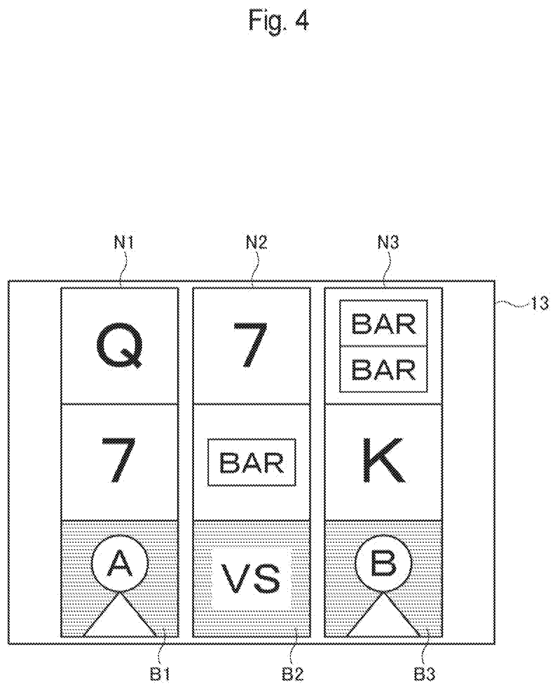

Referring to FIG. 4 to FIG. 9, an example of a slot game that can be provided to a player by the game device 1 according to the embodiment is described. FIG. 4 is a diagram illustrating an example of images displayed on the display unit when a condition to start a bonus game is satisfied in a normal game provided by the game device according to the embodiment.

The selection unit 31 selects one self-character allocated to the player, and selects one opponent character which is an opponent for the self-character. For example, the selection unit 31 selects the self-character and the opponent character on the basis of symbols displayed at rest in a normal game.

Specifically, the control circuit 22 refers to self-character information stored in the main memory 21, which defines a plurality of self-characters, to execute selection operation for selecting one self-character information. Similarly, the control circuit 22 refers to opponent character information stored in the main memory 21, which defines a plurality of opponent characters, to execute selection operation for selecting one opponent character information.

The normal game is a slot game that is started when the player sets a credit depending on a bill or a ticket inserted to the bill insertion unit 16 and the player inputs an instruction to bet and start to the game device 1.

Specifically, as illustrated in FIG. 4, the selection unit 31 selects a character “A” rendered by a bonus symbol B1 displayed at rest in a display region at the third stage from the top of a reel N1 displayed on the display unit 13 as a self-character. Similarly, the selection unit 31 selects a character “B” rendered by a bonus symbol B3 displayed at rest in a display region at the third stage from the top of a reel N3 as an opponent character. Note that a bonus symbol B2 displayed at rest in a display region at the third stage from the top of a reel N2 means that the character “A” and the character “B” play each other.

For example, when the bonus symbol B1, the bonus symbol B2, and the bonus symbol B3 are displayed at rest in any one of separate display regions of the reel N1, the reel N2, and the reel N3, the game device 1 starts a bonus game comprising matchup of the character “A” and the character “B”. The bonus game is a slot game that can be played for a designated number of times without using any credit, and is started when a predetermined condition is satisfied.

After it is determined that the self-character beat the opponent character, the selection unit 31 determines whether there is another opponent character. When the selection unit 31 determines that there is another opponent character, the selection unit 31 selects the other opponent character.

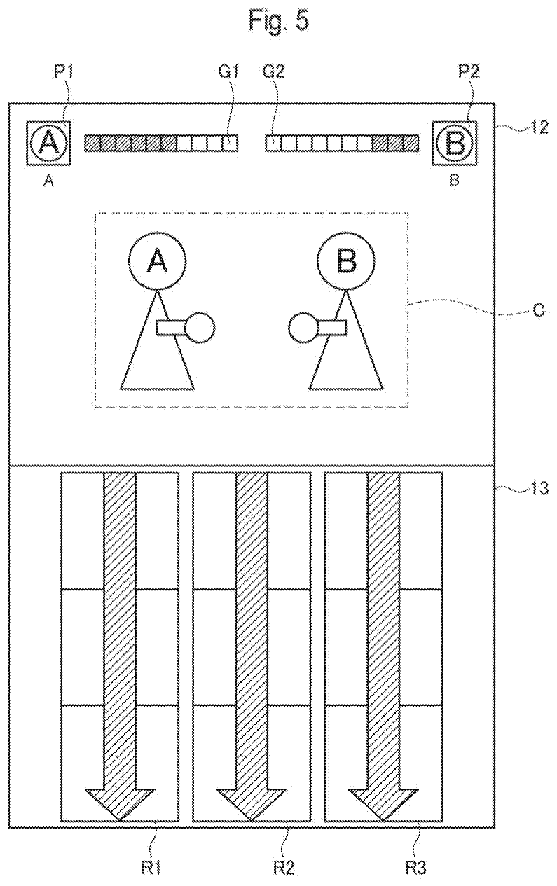

FIG. 5 is a diagram illustrating an example of images displayed on the display unit in a bonus game provided by the game device according to the embodiment. For example, in the bonus game, the display control unit 32 displays an image C, an image P1, an image P2, an image G1, and an image G2 illustrated in FIG. 5 on the display unit 12.

The image C renders how the character “A” and the character “B” actually fight each other, and is displayed at the center of the display unit 12. The image P1 and the image P2 render an icon of a self-character and an icon of an opponent character, and are displayed at the upper left and the upper right of the display unit 12, respectively. The name of the self-character is displayed under the image P1, and the name of the opponent character is displayed under the image P2.

The image G1 and the image G2 indicate a first point allocated to the self-character and a second point allocated to the opponent character by diagonally hatched squares, respectively. The white squares indicate first points or second points already lost. The initial value of the first point and the initial value of the second point are 10 points.

For example, the display control unit 32 variously displays the first symbol, the second symbol, and the third symbol on the reel R1, the reel R2, and the reel R3 displayed on the display unit 13 as indicated by diagonally hatched arrows in FIG. 5. In the three reels, a plurality of symbols are virtually and continuously arranged in the vertical direction, and three stages of the plurality of symbols are displayed. The first symbol is a symbol allocated to the self-character. The second symbol is a symbol allocated to the opponent character. The third symbol is a symbol that is not allocated to either of the self-character and the opponent character. The variation display refers to high-speed scroll display of symbols for each reel.

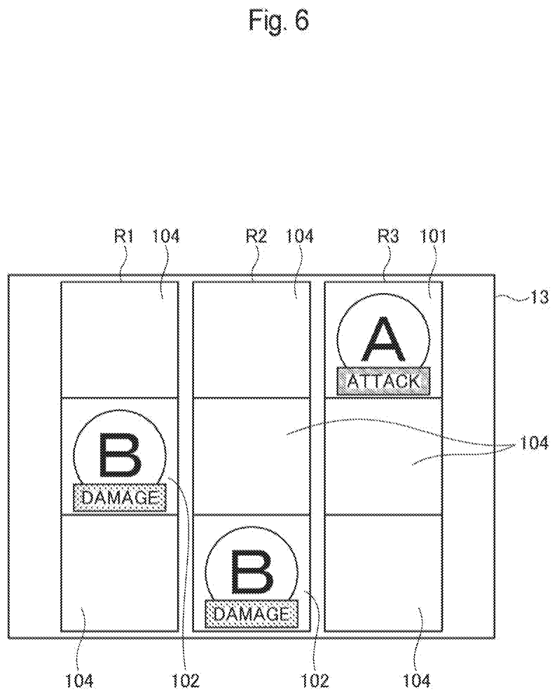

For example, as illustrated in FIG. 6, the display control unit 32 displays, on the basis of a lottery, at least one of a first symbol 101 allocated to the self-character “A” and a second symbol 102 allocated to the opponent character “B” at rest in separate display regions on the three reels.

Specifically, the control circuit 22 executes lottery operation, and refers to first symbol information and second symbol information to output images for displaying at least one of a first symbol 101 and a second symbol 102 in separate regions of the plurality of display regions. The first symbol information is information for displaying the first symbol 101 allocated to the self-character, and is stored in the main memory 21. Similarly, the second symbol information is information for displaying the second symbol 102 allocated to the opponent character, and is stored in the main memory 21.

The display at rest as used herein refers to decreasing the speed of scroll display from the state in which symbols are variously displayed for each reel, so that symbols are fixedly displayed for each reel.

The first symbol 101 is displayed at rest in a display region at the first stage from the top of a reel R3 illustrated in FIG. 6, and renders an icon of the self-character “A” and a letter of “ATTACK” indicating that the self-character makes an attack to the opponent character. The second symbols 102 are displayed at rest in a display region at the second stage from the top of a reel R1 illustrated in FIG. 6 and in a display region at the third stage from the top of a reel R2, and render icons of the opponent character “B” and a letter of “DAMAGE” indicating that the self-character is attacked by the opponent character and damaged. The first symbol 101 and the second symbol 102 are symbols different from each other. As illustrated in FIG. 6, blank symbols 104 are displayed at rest in display regions where the first symbol 101 or the second symbol 102 is not displayed at rest among display regions on the reel R1, the reel R2, and the reel R3. The blank symbol 104 is an example of the above-mentioned third symbol.

The point control unit 34 determines the magnitude relation between the number of the second symbols 102 displayed at rest and the number of the first symbols 101 displayed at rest. When the number of the second symbols 102 displayed at rest is larger than the number of the first symbols 101 displayed at rest, the point control unit 34 decreases a first point allocated to the self-character. When the number of the second symbols 102 displayed at rest is smaller than the number of the first symbols 101 displayed at rest, the point control unit 34 decreases a second point allocated to the opponent character.

Specifically, the control circuit 22 executes subtraction to decrease the first point when the number of the second symbols 102 is larger than the number of the first symbols 101, and executes subtraction to decrease the second point when the number of the second symbols 102 is smaller than the number of the first symbols 101. The first point and the second point are stored in the main memory 21.

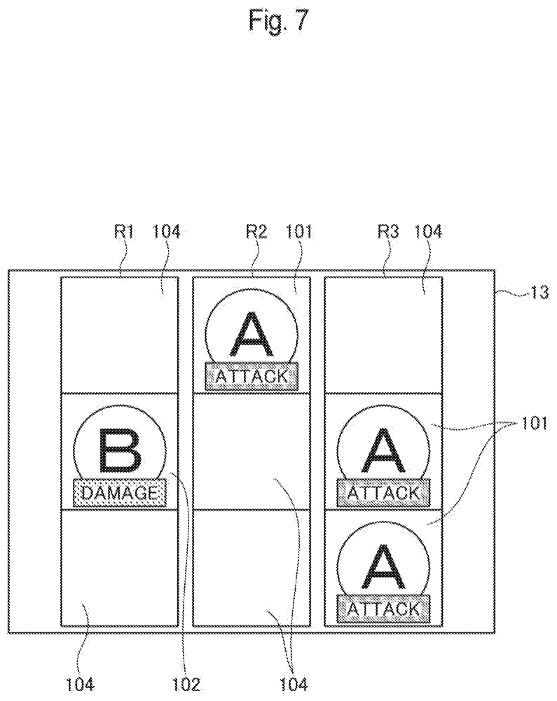

FIG. 6 is a diagram illustrating an example in which the number of second symbols displayed at rest is larger than the number of first symbols displayed at rest in a bonus game provided by the game device according to the embodiment. FIG. 7 is a diagram illustrating an example in which the number of second symbols displayed at rest is smaller than the number of first symbols displayed at rest in a bonus game provided by the game device according to the embodiment. For example, as illustrated in FIG. 6, when two second symbols 102 are displayed at rest and one first symbol 101 is displayed at rest, the point control unit 34 decreases a first point allocated to the self-character by “2”, which is the number of the second symbols 102. As illustrated in FIG. 7, when three first symbols 101 are displayed at rest and one second symbol 102 is displayed at rest, the point control unit 34 decreases a second point allocated to the opponent character by “3”, which is the number of the first symbols 101.

The determination unit 35 determines whether any one of the first point and the second point has reached a predetermined threshold or less. When any one of the first point and the second point has reached the predetermined threshold or less, the determination unit 35 determines that a character whose point has reached the threshold or less was defeated, and a character which is an opponent for the losing character won. Specifically, the control circuit 22 stores a determination flag indicating the determination result in the main memory 21. The predetermined threshold as used herein is, for example, “0” or “5”.

The determination unit 35 determines whether the first symbol 101 is displayed at rest in a predetermined form. When the first symbol 101 is displayed at rest in a predetermined form, for example, when first symbols 101 are displayed at rest in all display regions on the reel R1, the reel R2, and the reel R3, the determination unit 35 may determine that the self-character beat the opponent character.

When it is determined that the self-character beat the opponent character, the dividend unit 36 pays a predetermined dividend. Specifically, the control circuit 22 refers to a determination flag stored in the main memory 21 to calculate a dividend that should be paid when it is determined that the self-character beat the opponent character, and stores the calculated dividend in the main memory 21.

The dividend unit 36 may change the dividend depending on at least one of the type of opponent character selected when it is determined that the self-character beat the opponent character and the number of times of determination that the self-character won. Furthermore, the dividend unit 36 may pay a predetermined dividend on the basis of the number of first symbols 101 displayed at rest in the bonus game.

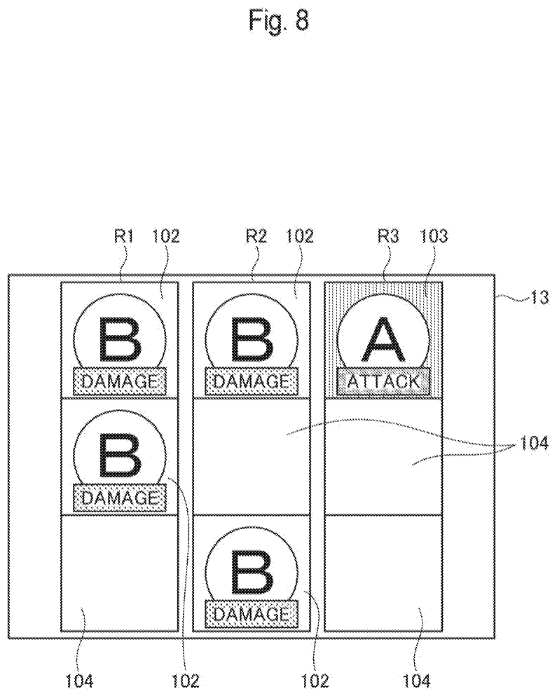

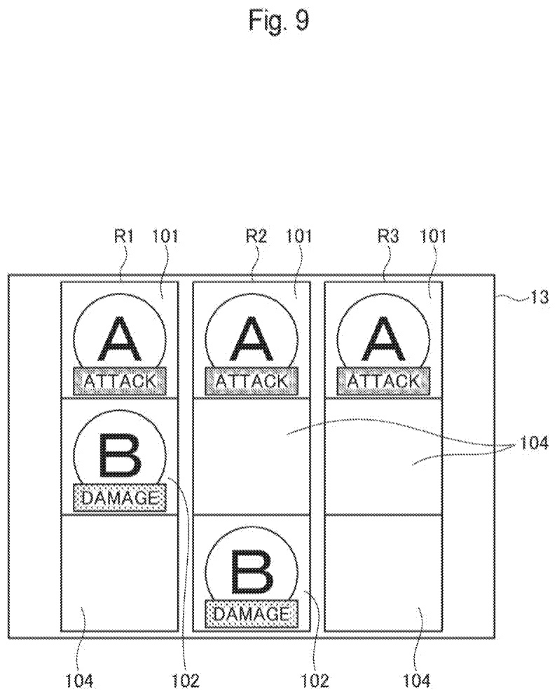

FIG. 8 is a diagram illustrating an example where a special symbol is stopped and displayed in a bonus game provided by the game device according to the embodiment. FIG. 9 is a diagram illustrating an example where symbols having a predetermined positional relationship with the special symbol are rewritten by first symbols in a bonus game provided by the game device according to the embodiment.

The rewriting unit 33 determines whether a stopped and displayed symbol satisfies a predetermined condition, and when the stopped and displayed symbol satisfies the predetermined condition, rewrites a symbol having a predetermined positional relationship with the symbol by a first symbol 101. Regarding the predetermined condition, the special symbol 103 is virtually disposed on the reel R3, and when the special symbol 103 is displayed at rest as illustrated in FIG. 8, two symbols displayed at rest on the left of the special symbol 103 in addition to the special symbol 103 are rewritten by the first symbols 101. The special symbol 103 renders an icon of the self-character “A” and a letter of “ATTACK” indicating that the self-character attacks the opponent character. The special symbol 103 has a vertical hatching around the self-character “A” so as to be distinguished from the first symbol 101.

For example, as illustrated in FIG. 8, when a special symbol 103 is displayed at rest on the reel R3, the special symbol 103 and two second symbols 102 displayed at rest on the left of the special symbol 103 are rewritten by first symbols 101. In this manner, the state in which the number of the second symbols 102 is larger than the number of the first symbols 101 as illustrated in FIG. 8 is changed to the state in which the number of the first symbols 101 is larger than the number of the second symbols 102 as illustrated in FIG. 9. Thus, the rewriting unit 33 can reverse the competition situation of the self-character.

Various predetermined conditions for the rewriting unit 33 to rewrite a symbol by a first symbol 101 are conceivable. For example, when two or more first symbols 101 appear on the reel R3, a total of four symbols displayed at rest on the left of the two first symbols 101 may be rewritten by first symbols 101.

### Description of Processing

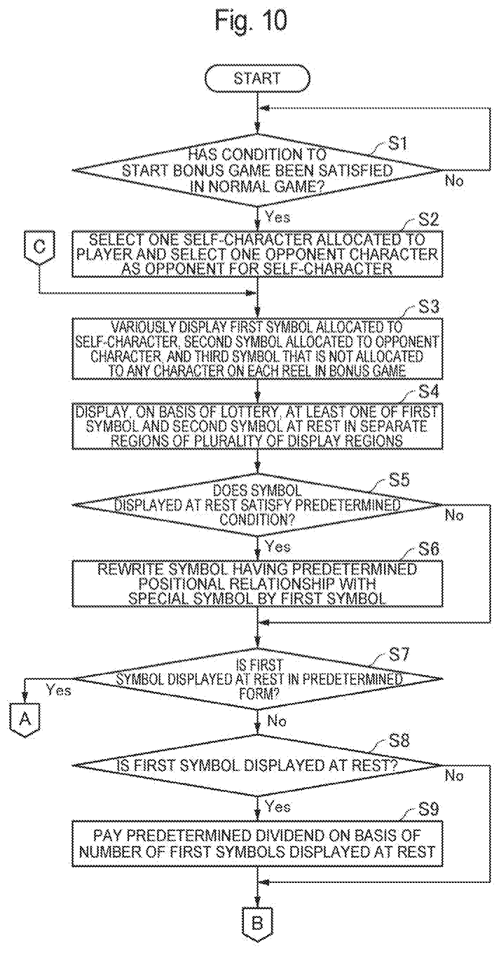

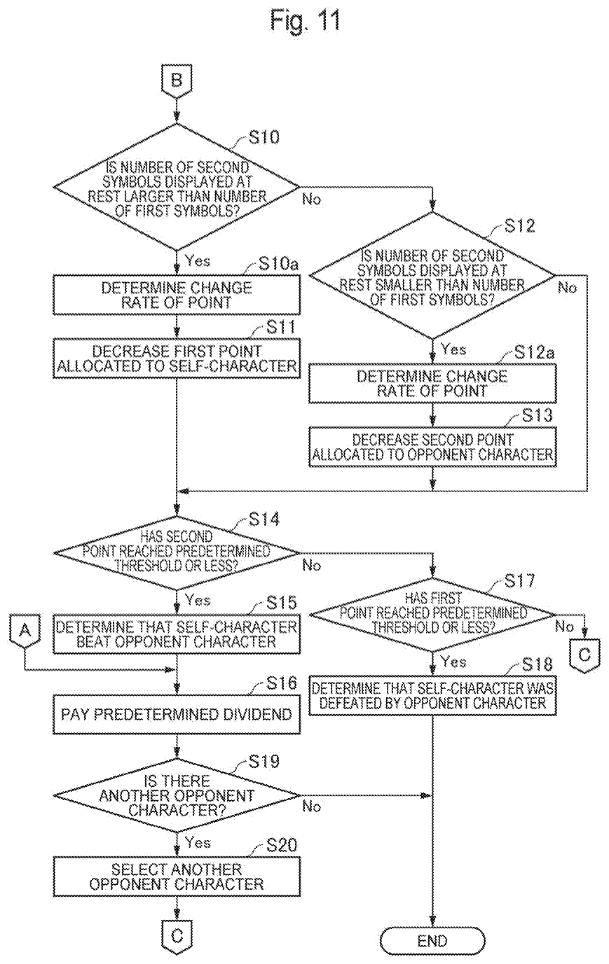

Referring to FIG. 10 and FIG. 11, an example of processing performed by the game device 1 is described. Steps included in the processing described below can be executed in a freely changed order or in parallel within the range not contradicting the contents of the processing, and another step may be added between steps. A step described as one step for the sake of convenience can be executed while being divided into a plurality of steps. Steps described as a plurality of divided steps for the sake of convenience can be grasped as a single step. The details of the processing of each step have been already described, and are omitted herein.

FIG. 10 and FIG. 11 are flowcharts for describing an example of the flow from the start to end of a bonus game provided by the game device according to the embodiment.

In Step S1, the game device 1 determines whether a condition that a bonus game is started has been satisfied in a normal game. When the game device 1 determines that the condition has been satisfied (Yes in Step S1), the game device 1 advances the processing to Step S2. When the game device 1 determines that the condition has not been satisfied (No in Step S1), the game device 1 stands by until the game device 1 determines that the condition has been satisfied.

In Step S2, the selection unit 31 selects one self-character allocated to a player, and selects one opponent character, which is an opponent for the self-character.

In Step S3, the display control unit 32 variously displays a first symbol 101 allocated to the self-character, a second symbol 102 allocated to the opponent character, and a third symbol that is not allocated to either of the characters on reels in a bonus game.

In Step S4, the display control unit 32 displays at least one of a first symbol 101 and a second symbol 102 at rest in separate regions of a plurality of display regions on the basis of a lottery.

In Step S5, the rewriting unit 33 determines whether the symbols displayed at rest satisfy a predetermined condition. When the rewriting unit 33 determines that the condition is satisfied (Yes in Step S5), the rewriting unit 33 advances the processing to Step S6. When the rewriting unit 33 determines that the condition is not satisfied (No in Step S5), the rewriting unit 33 advances the processing to Step S7.

In Step S6, the rewriting unit 33 rewrites a symbol having a predetermined positional relationship with the special symbol 103 by a first symbol 101.

In Step S7, the determination unit 35 determines whether the first symbol 101 is displayed at rest in a predetermined form. When the determination unit 35 determines that the first symbol 101 is displayed at rest in a predetermined form (No in Step S7), the determination unit 35 advances the processing to Step S8. When the determination unit 35 determines that the first symbol 101 is not displayed at rest in the predetermined form (Yes in Step S7), the determination unit 35 advances the processing to Step S16 illustrated in FIG. 11 as indicated by an off-page connector A in FIG. 10.

In Step S8, the dividend unit 36 determines whether the first symbol 101 is displayed at rest. When the dividend unit 36 determines that the first symbol 101 is displayed at rest (Yes in Step S8), the dividend unit 36 advances the processing to Step S9. When the dividend unit 36 determines that the first symbol 101 is not displayed at rest (No in Step S8), the dividend unit 36 advances the processing to Step S10.

In Step S9, the dividend unit 36 pays a predetermined dividend on the basis of the number of the first symbols 101 displayed at rest, and advances the processing to Step S10 illustrated in FIG. 11 as indicated by an off-page connector B in FIG. 10.

In Step S10, the point control unit 34 determines whether the number of the second symbols 102 displayed at rest is larger than the number of the first symbols 101 displayed at rest. When the number of the second symbols 102 displayed at rest is larger than the number of the first symbols 101 displayed at rest (Yes in Step S10), the point control unit 34 advances the processing to Step S10a, and determines the change rate of the point.

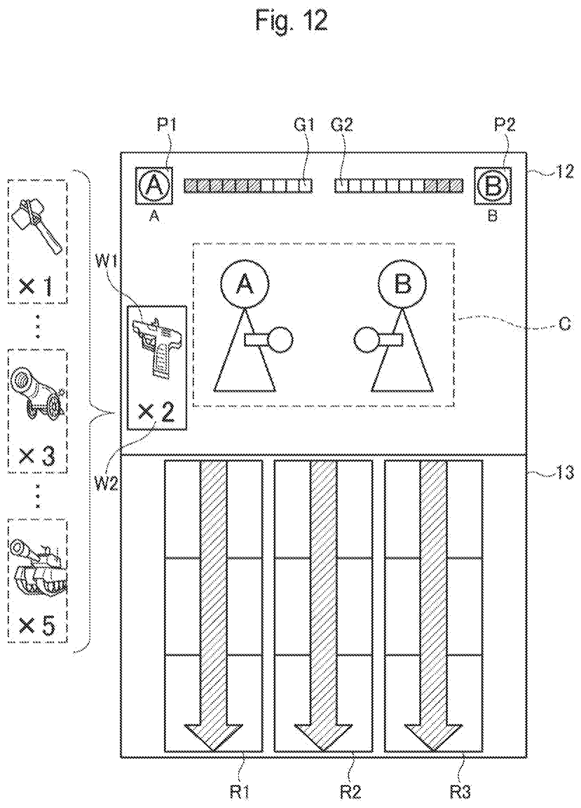

FIG. 12 is a diagram illustrating an example of images displayed on the display unit in a bonus game, in which an image W1 of a weapon item and an image W2 indicating attack capability corresponding to the weapon item are displayed in addition to FIG. 5.

The weapon item and the attack capability indicate the magnitude of a point to be changed (hereinafter referred to as “change rate of point”). In the example in FIG. 12, an image W1 of “pistol” is displayed as a weapon item, and an image W2 indicating that the attack capability is “×2 (=2 times)” is displayed.

The point control unit 34 determines a weapon item and its attack capability in accordance with a predetermined condition (for example, lottery). Note that, in this embodiment, it is assumed that the attack capability is freely set between “×1 (=1 time)” and “×5 (=5 times)” (see portion surrounded by broken line in FIG. 12), but not only the attack capability but also the type and number of weapon items can be freely set and changed.

After the point control unit 34 determines the change rate of the point in accordance with the weapon item and the attack capability displayed on the display unit (Step S10a), the point control unit 34 proceeds to Step S11.

In Step S11, the point control unit 34 decreases the first point allocated to the self-character in accordance with the determined point change rate. In this example, the attack capability (point change rate) is set to “×2 (=2 times)”, and hence a point twice the normal point is decreased. In the example in FIG. 6, the first point allocated to the self-character is decreased by the point twice the normal point, that is, 4 points (=2 points×2).

On the other hand, when the number of the second symbols 102 is smaller than the number of the first symbols 101 (No in Step S10), the point control unit 34 advances the processing to Step S12.

In Step S12, the point control unit 34 determines whether the number of the second symbols 102 displayed at rest is smaller than the number of the first symbols 101 displayed at rest. When the number of the second symbols 102 is smaller than the number of the first symbols 101 (Yes in Step S12), the point control unit 34 advances the processing to Step S12a, determines the change rate of the point, and proceeds to Step S13. Note that the operation for determining the point change rate indicated in Step S12a is similar to that in Step S10a, and hence description thereof is omitted.

After the point control unit 34 advances the processing to Step S13, the point control unit 34 decreases the second point allocated to the opponent character. In the example in FIG. 7, the second point allocated to the opponent character is decreased by a point twice the normal point, that is, 6 points (=3 points×2).

On the other hand, when the number of the second symbols 102 is not smaller than the number of the first symbols 101 in Step S12 (No in Step S12), the point control unit 34 advances the processing to Step S14.

In Step S14, the determination unit 35 determines whether the second point has reached a predetermined threshold or less. When the determination unit 35 determines that the second point has reached the predetermined threshold or less (Yes in Step S14), the determination unit 35 advances the processing to Step S15. When the determination unit 35 determines that the second point has not reached the predetermined threshold or less (No in Step S14), the determination unit 35 advances the processing to Step S17.

In Step S15, the determination unit 35 determines that the self-character beat the opponent character.

In Step S16, the dividend unit 36 pays a predetermined dividend.

In Step S17, the determination unit 35 determines whether the first point has reached a predetermined threshold or less. When the determination unit 35 determines that the first point has reached the predetermined threshold or less (Yes in Step S17), the determination unit 35 advances the processing to Step S18. When the determination unit 35 determines that the first point has not reached the predetermined threshold or less (No in Step S17), the determination unit 35 returns the processing to Step S3 illustrated in FIG. 10 as indicated by an off-page connector C in FIG. 11.

In Step S18, the determination unit 35 determines that the self-character was defeated by the opponent character, and finishes the bonus game.

In Step S19, the selection unit 31 determines whether there is another opponent character. When the selection unit 31 determines that there is another opponent character (Yes in Step S19), the selection unit 31 advances the processing to Step S20. When the selection unit 31 determines whether there are no other opponent characters (No in Step S19), the selection unit 31 finishes the bonus game.

In Step S20, the selection unit 31 selects another opponent character, and returns the processing to Step S3 illustrated in FIG. 10 as indicated by an off-page connector C in FIG. 11.

The embodiment as an example of the present disclosure has been described above. The game device 1 according to the embodiment selects a self-character and an opponent character, and decreases a first point or a second point depending on the magnitude relation between the number of stopped and displayed first symbols 101 and the number of stopped and displayed second symbols 102. When the second point has reached a predetermined threshold or less, the game device 1 determines that the self-character beat the opponent character, and pays a predetermined dividend. In this manner, the game device 1 can produce a competition between the self-character and the opponent character by a slot game, and can give the player an impressive feeling.

When it is determined that the self-character beat the opponent character, the game device 1 changes a dividend to be paid depending on the type of the opponent character, and hence can provide a realistic sensation to a competition between the self-character and the opponent character and give the player an impressive feeling.

The game device 1 pays a predetermined dividend depending on the number of first symbols 101 displayed at rest irrespective of whether the self-character beat the opponent character, and hence can maintain a feeling of anticipation of the player even when the self-character was defeated.

When a symbol displayed at rest satisfies a predetermined condition, the game device 1 rewrites a symbol having a predetermined positional relationship with the symbol by a first symbol 101. When the first symbol 101 is displayed at rest in a predetermined form, the game device 1 determines that the self-character beat the opponent character. Thus, the game device 1 can always leave the possibility that the self-character has an upset victory, and maintain a feeling of anticipation of the player.

### Application Example

In the above-mentioned embodiment, a mode in which a self-character and an opponent character are selected and a first point or a second point is decreased depending on the magnitude relation of the numbers of symbols allocated to the selected characters has been exemplified, but the embodiment is not limited thereto. For example, a new point may be added to the first point or the second point, rather than decreasing the first point or the second point.

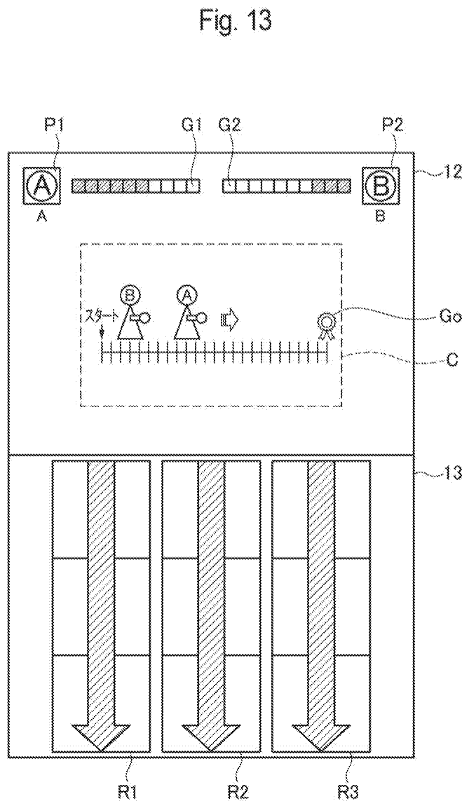

FIG. 13 is a diagram illustrating an application example of images displayed on the display unit in a bonus game, and corresponds to FIG. 5. An image C in FIG. 13 renders how the self-character “A” and the opponent character “B” compete toward a goal Go, and is displayed at the center of the display unit 12. Note that, in FIG. 13, portions corresponding to FIG. 5 are denoted by the same reference symbols, and descriptions thereof are omitted.

The point control unit 34 controls a point allocated to the self-character “A” or a point allocated to the opponent character “B” depending on the number of second symbols 102 displayed at rest and the number of first symbols 101 displayed at rest.

For example, when the number of the second symbols 102 displayed at rest is larger than the number of the first symbols 101 displayed at rest, the point control unit 34 adds (gives) a new point to the second point allocated to the opponent character.

On the other hand, when the number of the second symbols 102 displayed at rest is smaller than the number of the first symbols 101 displayed at rest, the point control unit 34 gives a new point to the first point allocated to the self-character. Note that the point control unit 34 may freely determine the number of points to be given (that is, change rate of point) on the basis of the difference between the number of the first symbols 101 and the number of the second symbols 102.

When the number of points to be given is determined by the point control unit 34, the display control unit 32 advances a character to be given a point toward the goal Go by the given point.

For example, a character to be given a point is the self-character “A” and the given point is “2 points”, an image indicating that the self-character “A” goes forward two squares toward the goal Go is displayed on the display unit 12 (see arrow illustrated in FIG. 13).

The determination unit 35 determines whether any one of the first point allocated to the self-character “A” and the second point allocated to the opponent character “B” has reached a predetermined threshold (in other words, goal Go). When any one of the first point and the second point has reached the predetermined threshold, the determination unit 35 determines that a character whose point has reached the threshold won and a character which is an opponent for the winning character was defeated. Specifically, the control circuit 22 stores a determination flag indicating the determination result in the main memory 21. The predetermined threshold as used herein is, for example, “15” or “30”.

The dividend unit 36 pays a predetermined dividend when the determination unit 35 determines that the self-character beat the opponent character. Specifically, the control circuit 22 refers to a determination flag stored in the main memory 21 to calculate a dividend that should be paid when it is determined that the self-character beat the opponent character, and stores the calculated dividend in the main memory 21. Note that a processing flow from the start to end of a bonus game according to the application example can be described similarly to the above-mentioned embodiment, and hence description thereof is omitted.

As described above, a new point may be added to the first point or the second point depending on the magnitude relation of the numbers of symbols allocated to selected characters. In this manner, a realistic sensation can be provided to a competition between the self-character and the opponent character, and an impressive feeling can be given to the player.

Note that, in the above-mentioned example, a mode in which only the point allocated to any one of characters is decreased (or new point is given) depending on the magnitude relation of the numbers of symbols allocated to the characters has been exemplified, but the embodiment is not limited thereto. For example, the point of each character may be decreased (or new point is given) by the number of allocated symbols.

Taking FIG. 6 as an example, when two second symbols 102 allocated to the opponent character are displayed at rest and one first symbol 101 allocated to the self-character is displayed at rest, the first point allocated to the self-character may be decreased by “2”, which is the number of the second symbols 102, and the second point allocated to the opponent character may be decreased by “1”, which is the number of the first symbols 101.

Note that the change rate of the point may be determined at random by a lottery or may be determined such that the numbers of wins and losses are balanced among characters in consideration of the past win loss history.

### LIST OF REFERENCE NUMERALS

1 Game device

11 Speaker

12, 13 Display unit

14 Operation input unit

15 Card reading unit

16 Bill insertion unit

17 Ticket withdrawal unit

2 Computing device

21 Main memory

22 Control circuit

23 BIOS-ROM

24 Storage unit

25 Voice processing unit

26 Image processing circuit

27 Communication interface

28 Peripheral interface

29 System bus

31 Selection unit

32 Display control unit

33 Rewriting unit

34 Point control unit

35 Determination unit

36 Dividend unit

101 First symbol

102 Second symbol

103 Special symbol

104 Blank symbol

B1, B2, B3 Bonus symbol

C, G1, G2, P1, P2 Image

N1, N2, N3, R1, R2, R3 Reel

1. A game device, comprising:
a selection unit for selecting one self-character allocated to a player, and selecting one opponent character, which is an opponent for the self-character;
a display control unit for displaying, on the basis of a lottery, at least one of a first symbol allocated to the self-character and a second symbol allocated to the opponent character at rest in separate regions of a plurality of display regions;
a point control unit for giving a point to a first point allocated to the self-character or a second point allocated to the opponent character in accordance with numbers of the first symbols and the second symbols displayed at rest;
a determination unit for determining, when any one of the first point and the second point has reached a predetermined threshold, that a character whose point has reached the threshold won and a character which is an opponent for the winning character was defeated; and
a dividend unit for paying a predetermined dividend when it is determined that the self-character beat the opponent character.

2. The game device according to claim 1, wherein the point control unit comprises a changing unit for changing a value of the point to be given depending on a predetermined condition.

3. A game device, comprising:
a selection unit for selecting one self-character allocated to a player, and selecting one opponent character, which is an opponent for the self-character;
a display control unit for displaying, on the basis of a lottery, at least one of a first symbol allocated to the self-character and a second symbol allocated to the opponent character at rest in separate regions of a plurality of display regions;
a point control unit for decreasing a first point allocated to the self-character when a number of the second symbols displayed at rest is larger than a number of the first symbols displayed at rest, and decreasing a second point allocated to the opponent character when the number of the second symbols displayed at rest is smaller than the number of the first symbols displayed at rest;
a determination unit for determining, when any one of the first point and the second point has reached a predetermined threshold or less, that a character whose point has reached the threshold or less was defeated and a character which is an opponent for the losing character won; and
a dividend unit for paying a predetermined dividend when it is determined that the self-character beat the opponent character.

4. The game device according to claim 3, wherein the point control unit comprises a changing unit for changing a value of a point to be decreased under a predetermined condition.

5. The game device according to claim 1, wherein
the selection unit selects another opponent character when it is determined that the self-character beat the opponent character, and
the dividend unit changes the dividend depending on at least one of a type of the opponent character selected when it is determined that the self-character beat the opponent character and a number of times of determination that the self-character won.

6. The game device according to claim 1, wherein the dividend unit further pays a predetermined dividend on the basis of a number of the first symbols displayed at rest.

7. The game device according to claim 1, further comprising a rewriting unit for rewriting, when a symbol displayed at rest satisfies a predetermined condition, a symbol having a predetermined positional relationship with the symbol by the first symbol.

8. The game device according to claim 1, wherein the determination unit determines, when the first symbol is displayed at rest in a predetermined form, that the self-character beat the opponent character.

9. A game device, comprising:
a memory;
a control circuit connected to the memory; and
an image processing circuit for displaying a predetermined image in a predetermined display region, wherein
the memory stores therein:
self-character information defining a plurality of self-characters;
opponent character information defining a plurality of opponent characters;
first symbol information for displaying a first symbol allocated to the self-character;
second symbol information for displaying a second symbol allocated to the opponent character;
a first point allocated to the self-character; and
a second point allocated to the opponent character, and
the control circuit is configured to:
refer to the self-character information stored in the memory to execute selection operation for selecting one self-character allocated to a player;
refer to the opponent character information stored in the memory to execute selection operation for selecting one opponent character which is an opponent for the self-character;
perform lottery operation;
refer, on the basis of the lottery operation, to the first symbol information and the second symbol information stored in the memory to output images for displaying at least one of a first symbol and a second symbol at rest in separate regions of a plurality of display regions;
execute subtraction for decreasing the first point when a number of the second symbols displayed at rest is larger than a number of the first symbols displayed at rest;
execute subtraction for decreasing the second point when the number of the second symbols displayed at rest is smaller than the number of the first symbols displayed at rest;
store, when any one of the first point and the second point has reached a predetermined threshold or less, a determination flag indicating that a character whose point has reached the threshold or less was defeated and a character which is an opponent for the losing character won in the memory; and
refer to the determination flag stored in the memory to calculate a dividend to be paid when it is determined that the self-character beat the opponent character, and store the calculated dividend in the memory.

10. A game method, comprising the steps of:
selecting one self-character allocated to a player, and selecting one opponent character, which is an opponent for the self-character;
displaying, on the basis of a lottery, at least one of a first symbol allocated to the self-character and a second symbol allocated to the opponent character at rest in separate regions of a plurality of display regions;
decreasing a first point allocated to the self-character when a number of the second symbols displayed at rest is larger than a number of the first symbols displayed at rest, and decreasing a second point allocated to the opponent character when the number of the second symbols displayed at rest is smaller than the number of the first symbols displayed at rest;
determining, when any one of the first point and the second point has reached a predetermined threshold or less, that a character whose point has reached the threshold or less was defeated and a character which is an opponent for the losing character won; and
paying a predetermined dividend when it is determined that the self-character beat the opponent character.
